(19) United States
(12) Patent Application Publication
(10) Pub. No.: US 2023/0136272 A1
(43) Pub. Date: May 4, 2023

(54) COMPACT LIDAR SYSTEMS FOR DETECTING OBJECTS IN BLIND-SPOT AREAS

(71) Applicant: Innovusion, Inc., Sunnyvale, CA (US)

(72) Inventors: Yufeng Li, Milpitas, CA (US); Haosen Wang, Sunnyvale, CA (US); Ching-Ling Meng, Sunnyvale, CA (US); Yimin Li, Cupertino, CA (US); Ning-Yi Wang, Fremont, CA (US); Junwei Bao, Los Altos, CA (US)

(73) Assignee: Innovusion, Inc., Sunnyvale, CA (US)

(21) Appl. No.: 17/975,539

(22) Filed: Oct. 27, 2022

Related U.S. Application Data
(63) Continuation of application No. 63/292,404, filed on Dec. 21, 2021.
(60) Provisional application No. 63/273,802, filed on Oct. 29, 2021.

(51) Int. Cl. G01S 17/10; G01S 7/481; G01S 17/89; G01S 17/931

(52) U.S. Cl. CPC G01S 17/10; G01S 7/4813; G01S 7/4817; G01S 17/89; G01S 17/931

(57) ABSTRACT

A light detection and ranging (LiDAR) system for detecting objects in blind-spot areas is provided. The system comprises a housing, a scanning-based LiDAR assembly disposed in the housing, and a non-scanning-based LiDAR assembly also disposed in the housing. The scanning-based LiDAR assembly is configured to scan a plurality of light beams to illuminate a first field-of-view (FOV). The non-scanning-based LiDAR assembly is configured to transmit laser light to illuminate a second FOV without scanning. The scanning-based LiDAR assembly's detection distance range extends beyond the detection distance range of the non-scanning-based LiDAR assembly.

### CROSS-REFERENCE TO RELATED APPLICATIONS

This application claims priority to U.S. Provisional Patent Application Ser. No. 63/273,802, filed Oct. 29, 2021, entitled “Compact Lidar Systems For Detecting Objects In Blind-Spot Areas,” and U.S. Provisional Patent Application Ser. No. 63/292,404, filed Dec. 21, 2021, entitled “Compact Lidar Systems For Detecting Objects In Blind-Spot Areas.” This application relates to a co-pending U.S. patent application filed on Oct. 27, 2022, attorney docket number 10325-2004900, entitled “Compact Lidar Systems For Detecting Objects In Blind-Spot Areas.” The content of the aforementioned provisional applications is hereby incorporated by reference in its entirety for all purposes.

### FIELD OF THE TECHNOLOGY

This disclosure relates generally to optical scanning and, more particularly, to a compact light detection and ranging (LiDAR) systems for detecting objects in blind-spot areas.

### BACKGROUND

Light detection and ranging (LiDAR) systems use light pulses to create an image or point cloud of the external environment. Some typical LiDAR systems include a light source, a light transmitter, a light steering system, and a light detector. The light source generates a light beam that is directed by the light steering system in particular directions when being transmitted from the LiDAR system. When a transmitted light beam is scattered by an object, a portion of the scattered light returns to the LiDAR system as a return light pulse. The light detector detects the return light pulse. Using the difference between the time that the return light pulse is detected and the time that a corresponding light pulse in the light beam is transmitted, the LiDAR system can determine the distance to the object using the speed of light. The light steering system can direct light beams along different paths to allow the LiDAR system to scan the surrounding environment and produce images or point clouds. LiDAR systems can also use techniques other than time-of-flight and scanning to measure the surrounding environment.

### SUMMARY

Embodiments discussed herein refer to LiDAR systems and methods that can detect objects located in blind-spot areas of a vehicle's LiDAR system. Objects located in blind-spot areas can be either faraway or nearby. Detection of faraway objects requires a LiDAR system to have a longer detection range in the horizontal field-of-view (“FOV”), but may not require a large vertical FOV. Detection of nearby objects requires a LiDAR system to have a larger vertical FOV, but may not require a long detection range. The embodiments discussed herein enable the detection of both faraway and nearby objects in one LiDAR system while keeping a compact design of the system.

In one embodiment, a LiDAR system for use with a vehicle to detect objects in blind-spot areas is provided. The system includes a housing and a scanning-based LiDAR assembly disposed in the housing. The scanning-based LiDAR assembly is configured to scan a plurality of light beams to illuminate a first FOV. The system further includes a non-scanning-based LiDAR assembly disposed in the housing. The non-scanning-based LiDAR assembly is configured to transmit laser light to illuminate a second FOV without scanning. The scanning-based LiDAR assembly's detection distance range extends beyond the non-scanning-based LiDAR assembly's detection distance range.

In one embodiment, a method for detecting objects in blind-spot areas is provided. The method comprises scanning, by a scanning-based LiDAR assembly disposed in a housing of the LiDAR system, a plurality of light beams to illuminate a first FOV. The method further comprises transmitting, by a non-scanning-based LiDAR assembly disposed in the housing, laser light to illuminate a second FOV without scanning. The scanning-based LiDAR assembly's detection distance range extends beyond the non-scanning-based LiDAR assembly's detection distance range.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more exemplary LiDAR systems disposed or included in a motor vehicle.

FIG. 2 is a block diagram illustrating interactions between an exemplary LiDAR system and multiple other systems including a vehicle perception and planning system.

FIG. 3 is a block diagram illustrating an exemplary LiDAR system.

FIG. 4 is a block diagram illustrating an exemplary fiber-based laser source.

FIGS. 5A-5C illustrate an exemplary LiDAR system using pulse signals to measure distances to objects disposed in a field-of-view (FOV).

FIG. 6 is a block diagram illustrating an exemplary apparatus used to implement systems, apparatus, and methods in various embodiments.

FIG. 7A illustrates a driver's horizontal blind-spot areas on the road from a top view.

FIG. 7B illustrates areas of a driver's vertical blind-spot areas from a perspective view.

FIG. 8A illustrates a LiDAR system capable of detecting objects in blind-spot areas according to one embodiment.

FIG. 8B illustrates a vertical FOV of a LiDAR system capable of detecting objects in blind-spot areas from a side view.

FIG. 8C illustrates an embodiment of a LiDAR system enclosed in a housing for detecting objects in blind-spot areas.

FIG. 9 is a block diagram of a LiDAR system capable of detecting objects in blind-spot areas according to one embodiment.

FIG. 10A illustrates a cross-section view of a scanning-based LiDAR assembly according to one embodiment.

FIG. 10B illustrates a scanning-based LiDAR assembly from the top view.

FIG. 11A illustrates a perspective view of a variable angle multi-facet polygon (“VAMFP”) according to one embodiment.

FIG. 11B illustrates side views of each facet of a variable angle multi-facet polygon according to one embodiment.

FIG. 11C illustrates a LiDAR system FOV with a combined bands from the plurality of facets of VAMFP according to one embodiment.

FIG. 12 illustrates a LiDAR system having a scanning LiDAR assembly but no non-scanning-based LiDAR assembly.

FIG. 13 is a flowchart illustrating a method for detecting objects in blind-spot areas.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

Although the following description uses terms “first,” “second,” etc. to describe various elements, these elements should not be limited by the terms. These terms are only used to distinguish one element from another. For example, a first wavelength could be termed a second wavelength and, similarly, a second wavelength could be termed a first wavelength, without departing from the scope of the various described examples. The first wavelength and the second wavelength can both be wavelengths and, in some cases, can be separate and different wavelengths.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Throughout the following disclosure, numerous references may be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, PLD, DSP, x86, ARM, RISC-V, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable medium storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, etc.). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

In the present disclosure, when a vertical angle of a LiDAR system's FOV is discussed, zero degree refers to the direction from the LiDAR system pointing parallel to the ground, i.e., the direction when drawing a horizontal line from the LiDAR system. Ninety degrees refers to the direction from the LiDAR system pointing perpendicularly towards the ground, i.e., the direction when drawing a gravity line from the LiDAR system. A negative degree refers to the angle between the horizontal line and a direction from the LiDAR system pointing upwards above the horizontal line.

In some embodiments, a LiDAR system mounted on top of a vehicle towards the front needs to detect objects in long distance in the horizontal direction. This is because while the vehicle is moving forward, objects in front of the vehicle, such as cars, pedestrians crossing the road, or traffic signs and signals, are of great importance to the safe driving of the vehicle. These objects may be located in far distance, e.g., several blocks away, but the vehicle still should be able to detect them to make the correct driving decisions. Such a LiDAR system, however, may not need to detect objects in a large vertical direction, because objects located in about 50° to 90° of the vertical FOV may be the vehicle's windshield and hood. An example LiDAR system installed on the top-front of a vehicle and front-facing may have an FOV of 120° in horizontal FOV and 30° in vertical FOV. Such a system, although having a smaller FOV, can detect objects in long distance, e.g., over 100 meters away.

The aforementioned LiDAR system has blind-spot areas, e.g., the areas outside the FOV of the LiDAR system, which includes areas on both sides of the vehicle and to the back of the vehicle. These blind-spot areas are of great importance to the safe driving of a vehicle when the vehicle, for example, turns, changes lanes, backs up or parks. Thus, in some embodiments, one or more separate LiDAR systems are required to detect objects in blind-spot areas. These objects are sometimes in close distance to the vehicle, e.g., a curb, a fire hydrant on a curb, or a child playing behind the vehicle, etc. To detect objects in close distance, a large vertical FOV is required. An example LiDAR system configured to detect blind-spot areas may have a larger FOV (compared to the example LiDAR system in the preceding paragraph) of 120° in horizontal FOV and 70° in vertical FOV. In addition, when a vehicle turns, detection of objects over 100 meters away, e.g., a fast-approaching vehicle on the other side of the crossroad trying to run a red light, may also be needed. As such, to assist the vehicle's turning and changing lanes, etc., a LiDAR system may need to be able to detect objects located both nearby and faraway.

Therefore, such a LiDAR system needs to have both a long detection range and a large vertical FOV.

The present disclosure discloses systems and methods for detecting both nearby objects with a large FOV and longer-range objects with a smaller FOV, while keeping a compact dimension so that the LiDAR system may be fit into, for example, a vehicle's side-view mirror or side panel.

Embodiments of present invention are described below. In various embodiments of the present invention, one embodiment of a LiDAR system includes a housing, a scanning-based LiDAR assembly disposed in the housing. The scanning-based LiDAR assembly is configured to scan a plurality of light beams to illuminate a first FOV. The LiDAR system further includes a non-scanning-based LiDAR assembly disposed in the housing. The non-scanning-based LiDAR assembly is configured to transmit laser light to illuminate a second FOV without scanning. A detection distance range of the scanning-based LiDAR assembly extends beyond a detection distance range of the non-scanning-based LiDAR assembly.

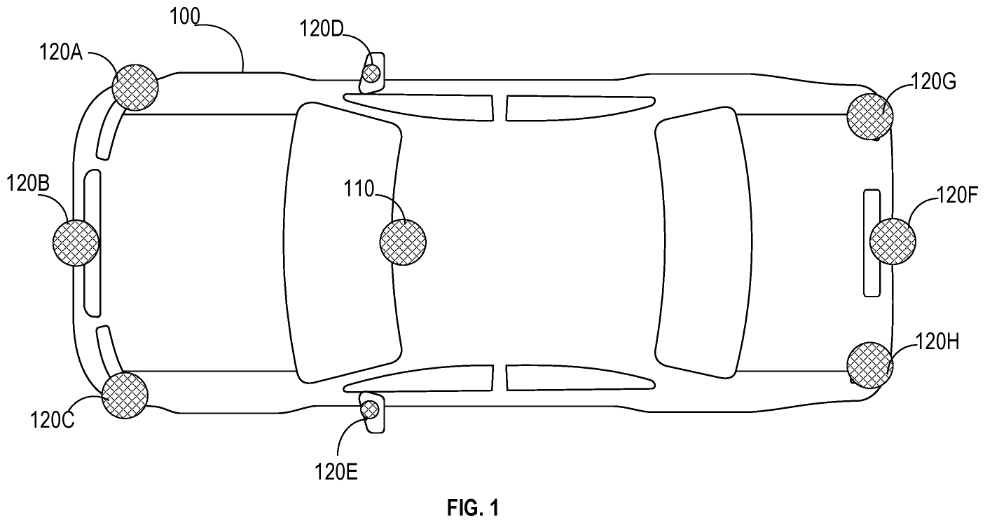

FIG. 1 illustrates one or more exemplary LiDAR systems 110 disposed or included in a motor vehicle 100. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-F. Each of LiDAR systems 110 and 120A-F can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning-based LiDAR system transmits laser light to illuminate an FOV without scanning. For example, a flash LiDAR is a type of non-scanning-based LiDAR system. A flash LiDAR can transmit laser light to simultaneously illuminate an FOV using a single light pulse or light shot.

A LiDAR system is often an essential sensor of a vehicle that is at least partially automated. In one embodiment, as shown in FIG. 1, motor vehicle 100 may include a single LiDAR system 110 (e.g., without LiDAR systems 120A-F) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-F. As shown in FIG. 1, in one embodiment, multiple LiDAR systems 110 and/or 120A-F are attached to vehicle 100 at different locations of the vehicle. For example, LiDAR system 120A is attached to vehicle 100 at the front right corner; LiDAR system 120B is attached to vehicle 100 at the front center; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; and/or LiDAR system 120F is attached to vehicle 100 at the back center. In some embodiments, LiDAR systems 110 and 120A-F are independent LiDAR systems having their own respective laser sources, control electronics, transmitters, receivers, and/or steering mechanisms. In other embodiments, some of LiDAR systems 110 and 120A-F can share one or more components, thereby forming a distributed sensor system. In one example, optical fibers are used to deliver laser light from a centralized laser source to all LiDAR systems. It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

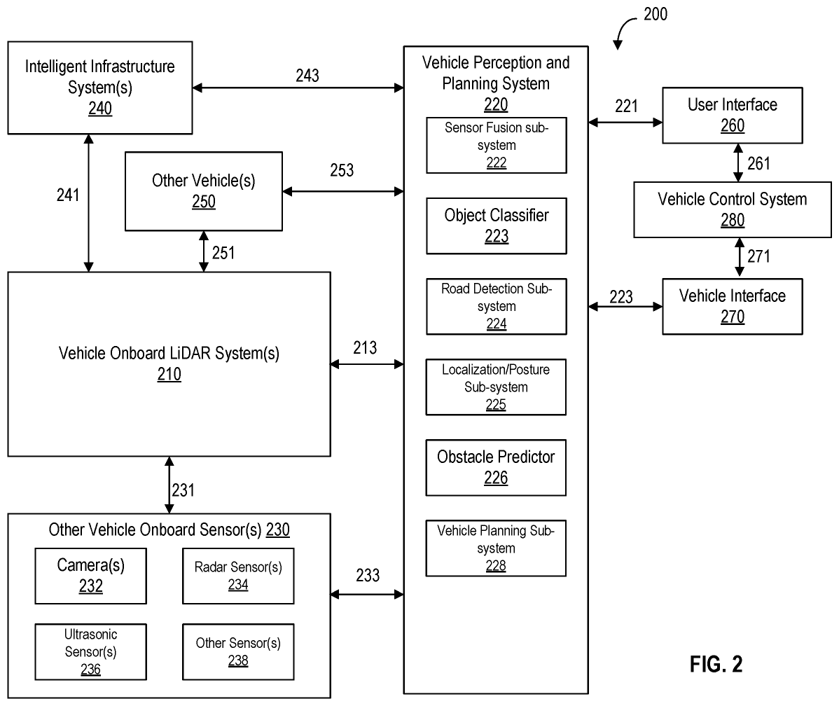

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-40 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 100-150 meters from the LiDAR sensor. Medium-range LiDAR sensors can be used for, e.g., monitoring road intersections, assistance for merging onto or leaving a freeway, or the like. A long-range LiDAR sensor measures objects located up to about 150-300 meters. Long-range LiDAR sensors are typically used when a vehicle is travelling at high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are used to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera produces monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data.

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind-spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations.

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, check blind-spot, identify parking spots, provide lane changing assistance into traffic, or the like. Sensor data generated by ultrasonic sensor(s) 236 can also be provided to vehicle perception and planning system 220 via communication path 233 for further processing and controlling the vehicle operations.

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud service for processing and then the processing results can be transmitted back to the vehicle perception and planning system 220).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is a behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210, thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffics in the opposite direction. In such a situation, sensors of intelligent infrastructure system(s) 240 can provide useful, and sometimes vital, data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. Vehicle perception and planning system 220 may further comprise a user interface 260, which provides a user (e.g., a driver) access to vehicle control system 280 to, for example, override or take over control of the vehicle when necessary. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

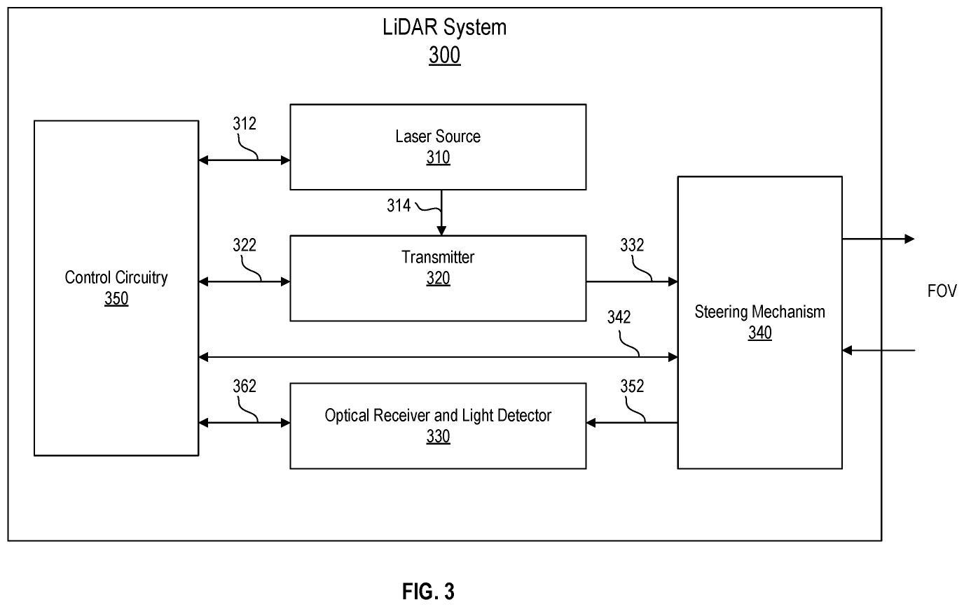

FIG. 3 is a block diagram illustrating an exemplary LiDAR system 300. LiDAR system 300 can be used to implement LiDAR system 110, 120A-F, and/or 210 shown in FIGS. 1 and 2. In one embodiment, LiDAR system 300 comprises a laser source 310, a transmitter 320, an optical receiver and light detector 330, a steering system 340, and a control circuitry 350. These components are coupled together using communications paths 312, 314, 322, 332, 343, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between laser source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Laser source 310 outputs laser light for illuminating objects in a field of view (FOV). Laser source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, laser source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, laser source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals.

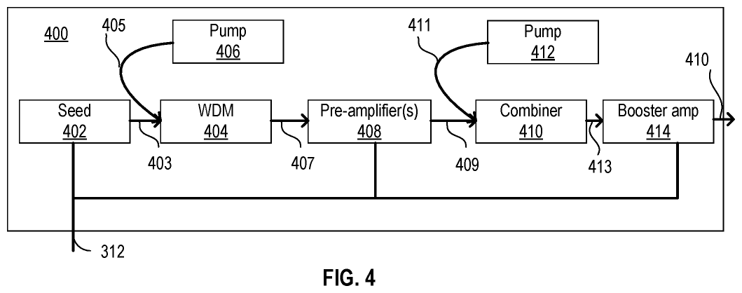

FIG. 4 is a block diagram illustrating an exemplary fiber-based laser source 400 having a seed laser and one or more pumps (e.g., laser diodes) for pumping desired output power. Fiber-based laser source 400 is an example of laser source 310 depicted in FIG. 3. In some embodiments, fiber-based laser source 400 comprises a seed laser 402 to generate initial light pulses of one or more wavelengths (e.g., 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 20-30 dB gain). In some embodiments, pre-amplifier(s) 408 are low noise amplifiers. Pre-amplifier(s) 408 output to a combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides pulses to a booster amplifier 414, which produces output light pulses via optical fiber 410. The booster amplifier 414 provides further amplification of the optical signals. The outputted light pulses can then be transmitted to transmitter 320 and/or steering mechanism 340 (shown in FIG. 3). It is understood that FIG. 4 illustrates one exemplary configuration of fiber-based laser source 400. Laser source 400 can have many other configurations using different combinations of one or more components shown in FIG. 4 and/or other components not shown in FIG. 4 (e.g., other components such as power supplies, lens, filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of laser source 310 comprise, for example, about 850 nm, about 905 nm, about 940 nm, about 1064 nm, and about 1550 nm. The upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from laser source 310 can be characterized by its peak power, average power, and the pulse energy. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. The PRR typically corresponds to the maximum range that a LiDAR system can measure. Laser source 310 can be configured to produce pulses at high PRR to meet the desired number of data points in a point cloud generated by the LiDAR system. Laser source 310 can also be configured to produce pulses at medium or low PRR to meet the desired maximum detection distance. Wall plug efficiency (WPE) is another factor to evaluate the total power consumption, which may be a key indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring laser source 310 and/or designing laser delivery systems for vehicle-mounted LiDAR applications.

It is understood that the above descriptions provide non-limiting examples of a laser source 310. Laser source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Laser source 310 provides laser light (e.g., in the form of a laser beam) to transmitter 320. The laser light provided by laser source 310 can be amplified laser light with a predetermined or controlled wavelength, pulse repetition rate, and/or power level. Transmitter 320 receives the laser light from laser source 310 and transmits the laser light to steering mechanism 340 with low divergence. In some embodiments, transmitter 320 can include, for example, optical components (e.g., lens, fibers, mirrors, etc.) for transmitting laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by laser source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, laser source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. Steering mechanism 340 will be described in more detail below. The laser light scanned to an FOV may be scattered or reflected by an object in the FOV. At least a portion of the scattered or reflected light returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focus, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One exemplary method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, a APD (avalanche photodiode) based structure, a PMT (photomultiplier tube) based structure, a SiPM (Silicon photomultiplier) based structure, a SPAD (single-photon avalanche diode) base structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise (TIA). In some embodiments, optical receiver and light detector 330 may include a pre-amplifier that is a low noise amplifier (LNA). In some embodiments, the pre-amplifier may also include a TIA-transimpedance amplifier, which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implement signal processing techniques (e.g., filtering, noise reduction, amplification, or the like). For example, in addition to or instead of using direct detection of return signals (e.g., by using TOF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism or a scanning mechanism. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an exemplary non-scanning LiDAR system).

Steering mechanism 340 can be used with the transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or two devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s) for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lens) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling laser source 310 to obtain desired laser pulse timing, repetition rate, and power; controlling steering mechanism 340 (e.g., controlling the speed, direction, and/or other parameters) to scan the FOV and maintain pixel registration/alignment; controlling optical receiver and light detector 330 (e.g., controlling the sensitivity, noise reduction, filtering, and/or other parameters) such that it is an optimal state; and monitoring overall system health/status for functional safety.

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; and/or determines any other type of data relevant to LiDAR system 300.

LiDAR system 300 can be disposed in a vehicle, which may operate in many different environments including hot or cold weather, rough road conditions that may cause intense vibration, high or low humidifies, dusty areas, etc. Therefore, in some embodiments, optical and/or electronic components of LiDAR system 300 (e.g., optics in transmitter 320, optical receiver and light detector 330, and steering mechanism 340) are disposed or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one exemplary LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

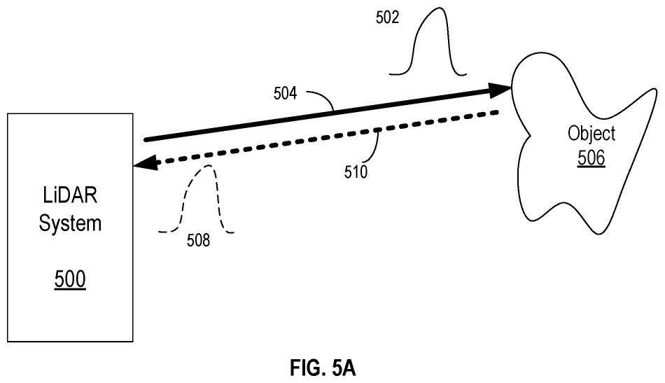

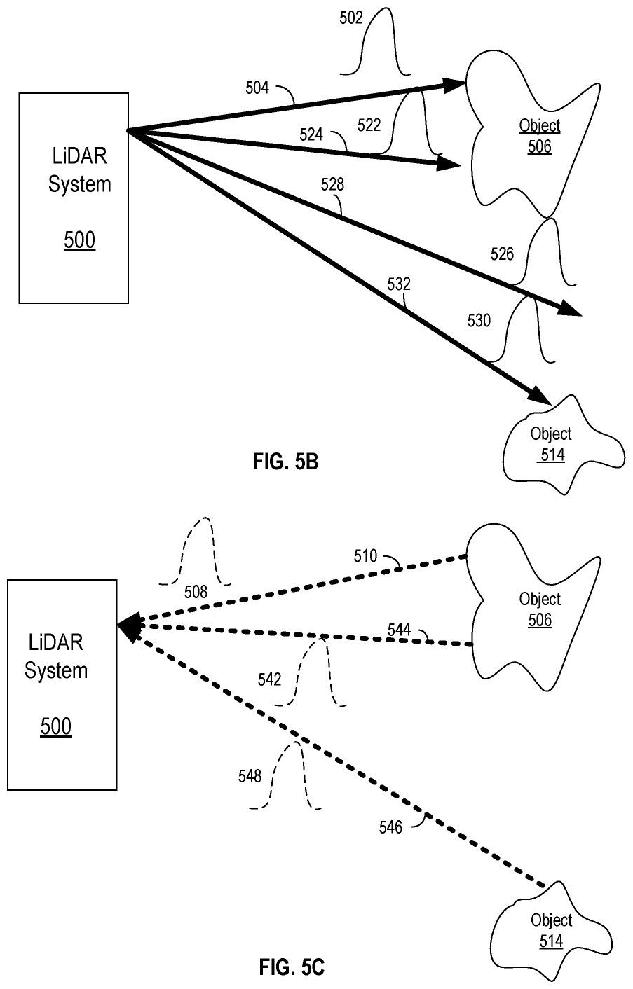

As described above, some LiDAR systems use the time-of-flight (TOF) of light signals (e.g., light pulses) to determine the distance to objects in a light path. For example, with reference to FIG. 5A, an exemplary LiDAR system 500 includes a laser light source (e.g., a fiber laser), a steering system (e.g., a system of one or more moving mirrors), and a light detector (e.g., a photon detector with one or more optics). LiDAR system 500 can be implemented using, for example, LiDAR system 300 described above. LiDAR system 500 transmits a light pulse 502 along light path 504 as determined by the steering system of LiDAR system 500. In the depicted example, light pulse 502, which is generated by the laser light source, is a short pulse of laser light. Further, the signal steering system of the LiDAR system 500 is a pulsed-signal steering system. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to generate a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are generated by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then it may be determined that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source with a higher pulse repetition rate (PRR) is needed. On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an exemplary LiDAR system that can transmit laser pulses with a repetition rate between 500 kHz and 1 MHz. Based on the time it takes for a pulse to return to the LiDAR system and to avoid mix-up of return pulses from consecutive pulses in a conventional LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

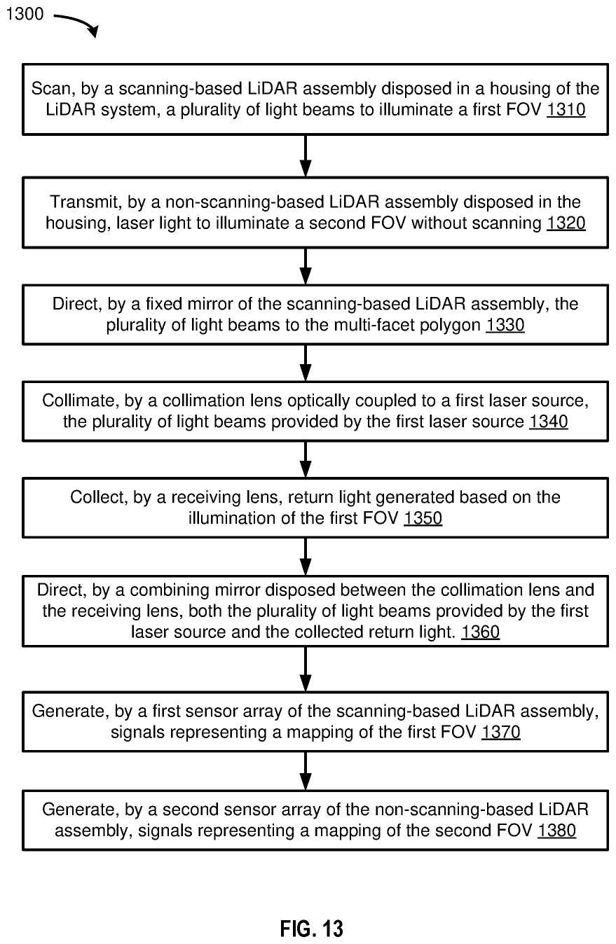

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of FIG. 13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

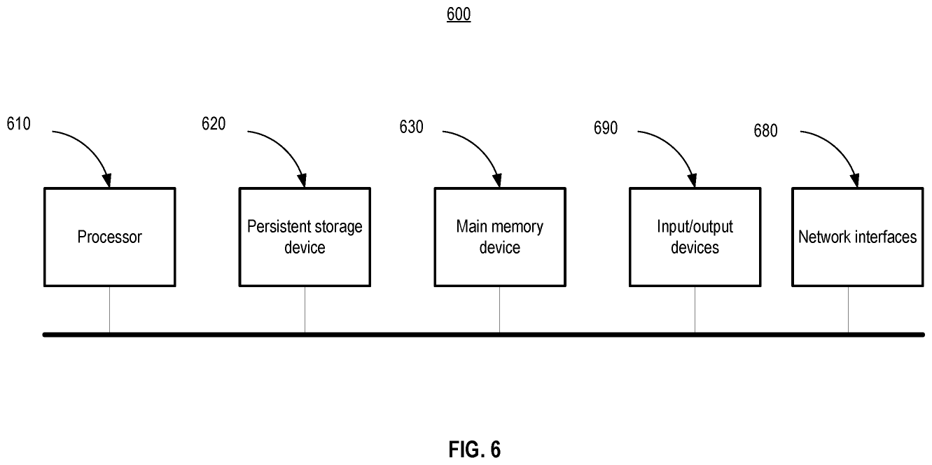

A high-level block diagram of an exemplary apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of FIG. 13 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps of FIG. 13. Accordingly, by executing the computer program instructions, the processor 610 executes an algorithm defined by the methods of FIG. 13. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

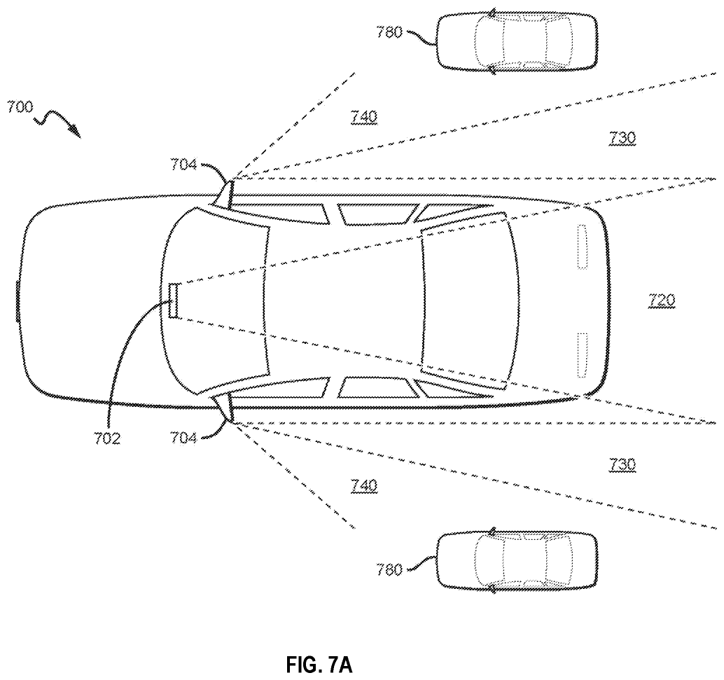

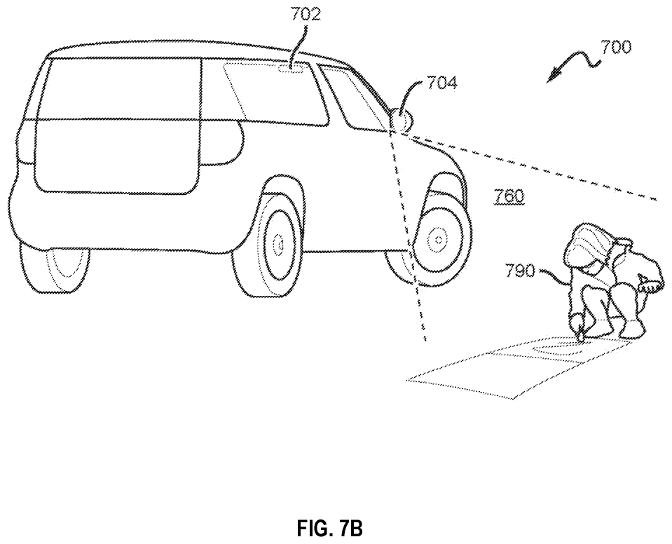

A “blind-spot”, as used in the present disclosure, can include, but is not limited to and can be different from, a “blind-spot” as used in common parlance, which essentially means a “driver's blind-spot”. A driver's blind-spot has two types. The first type of driver's blind-spot refers to areas on the road outside the driver's field of vision that cannot be seen by looking at both rear-view and side-view mirrors. This type of driver's blind-spot is referred to as a driver's horizontal blind-spot. The second type of driver's blind-spot refers to areas blocked by a structure of a vehicle, such as a vehicle's pillar or door. This type of driver's blind-spot is referred to as a driver's vertical blind-spot. The following FIGS. 7A and 7B illustrate a driver's blind-spot using an example where a human driver is located at the front left position inside the vehicle. It is understood that a driver may also be located at the front right position inside the vehicle. In some embodiments, there may not be a human driver inside the vehicle. As discussed in more detail below, a blind spot may thus be with respect to any particular location inside a vehicle, with respect to any LiDAR system mount to, or integrated with, a vehicle, and/or with respect to other components of the vehicle (e.g., a rear-view mirror, a camera, a radar sensor, or the like). Further, while the illustration in this disclosure uses a car or a sports utility vehicle as examples, it is understood that blind spots may exist for any other type of vehicles, including a boat, a plane, a train, a truck, a bus, drone, or any means for carrying or transporting things.

FIG. 7A illustrates a driver's horizontal blind-spot areas on the road from a top view. Vehicle 700 has a rear-view mirror 702 and two side-view mirrors 704. When a driver drives vehicle 700 on the road, the driver may see objects in rear-view range 720 when the driver looks into the rear-view mirror 702. When the driver looks into the two side view mirrors 704, the driver may see objects in side-view ranges 730 on both sides of the vehicle. Mostly due to the orientation and the size of the side-view mirrors, the side-view ranges are not wide enough to cover all the areas on the side of the vehicle. Therefore, without performing shoulder checking, the driver cannot see the driver's horizontal blind-spot areas 740 on both sides of the vehicle. These blind-spot areas can be large enough in size to block another vehicle (shown as vehicles 780 on both sides of vehicle 700, not drawn in scale), a cyclist or a pedestrian from the driver's view.

FIG. 7B illustrates areas of a driver's vertical blind-spot areas from a perspective view. A driver (not shown in the figure) sitting on the driver's seat on the left, cannot see objects in driver's vertical blind-spot area 760 because the driver's view is blocked by the side doors, and the objects are not viewable in either rear-view mirror 702 or side-view mirrors 704. Objects in driver's vertical blind-spot area 760 could be a parked motorcycle, or children playing on the side of the vehicle. Other than exercising vigilance, there may not be an effective way for a driver to thoroughly check objects hidden in driver's vertical blind-spot area 760, unless electronic devices such as a LiDAR system are used to aid the detection. Checking the driver's vertical blind-spot area 760 is important to the safe driving of the vehicle, especially when the vehicle is turning or parking.

A “blind-spot” used in the present disclosure refers to one or more areas that are outside an FOV of a particular LiDAR system of a vehicle, such as the vehicle's main LiDAR system. An exemplary main LiDAR system is shown as LiDAR system 110 in FIG. 1. For example, for a front-facing main LiDAR system mounted on top of a vehicle having a 120° horizontal FOV and a 30° vertical FOV, the blind-spot of the main LiDAR system covers the remaining 240° in horizontal FOV and 60° in vertical FOV (assuming the main LiDAR system only concerns 0° to 90° in vertical FOV). Therefore, in some embodiments, blind-spot areas of a LiDAR system mounted on a vehicle may cover a significant larger area than a driver's “blind-spot” area as described above.

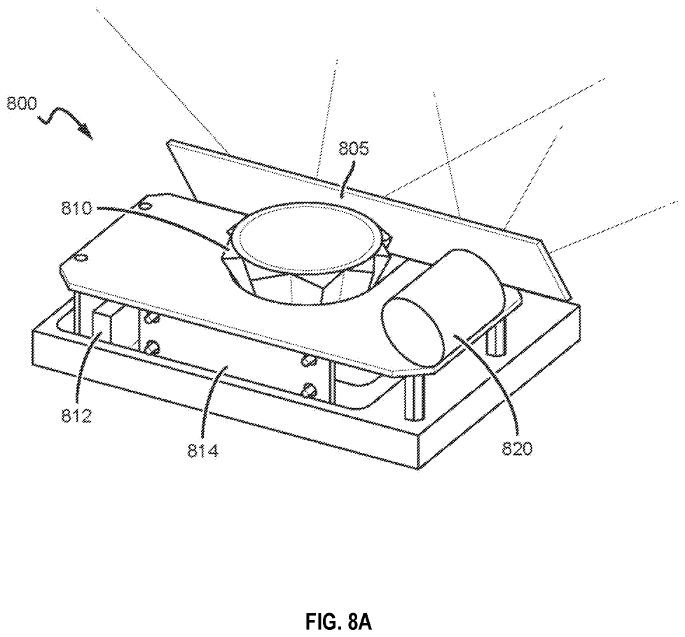

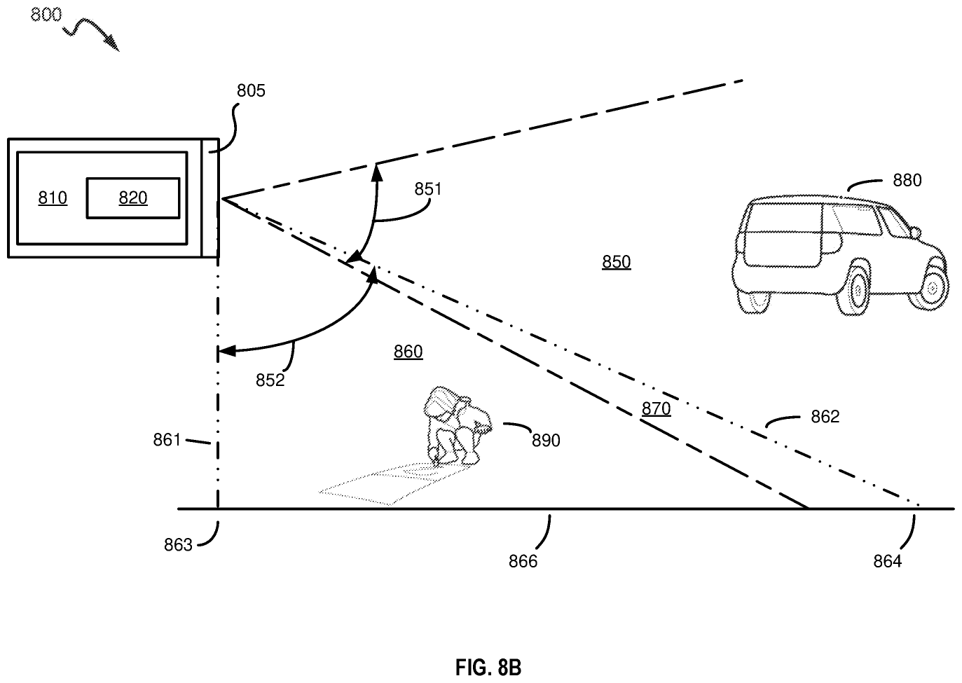

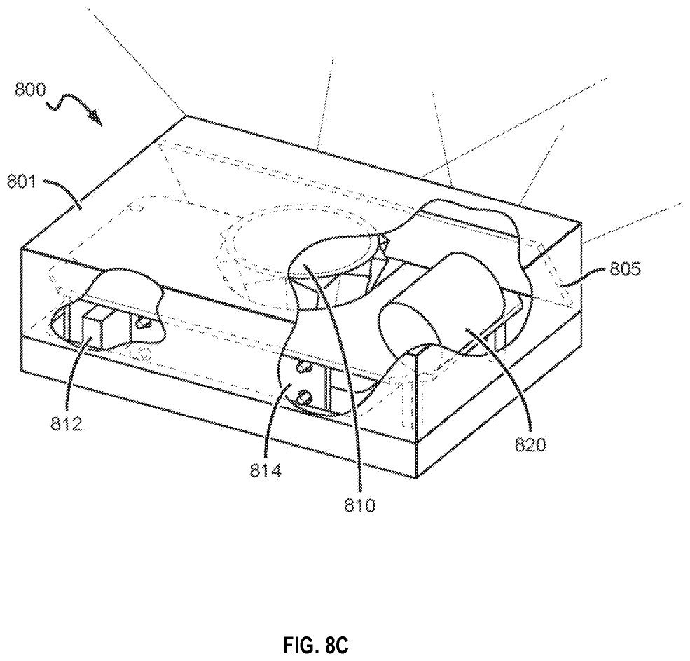

As explained above, to detect objects in blind-spot areas, a LiDAR system needs to have both a long detection range and a large vertical FOV. FIG. 8A illustrates a LiDAR system capable of detecting blind-spot areas according to one embodiment. LiDAR system 800 includes a scanning-based LiDAR assembly 810 and a non-scanning-based LiDAR assembly 820, both enclosed in a single housing (not shown in the figure) to keep a compact design. In other embodiments, scanning-based LiDAR assembly 810 and non-scanning-based LiDAR assembly 820 can have different housings. Window 805 facilitates the transmission of light to and from assemblies 810 and 820. Scanning-based LiDAR assembly 810 includes detector circuit board 812 and laser circuit board 814, which are described in greater detail below. Assembly 810 can cover a detection distance range of, for example, 100 meters, 150 meters, 200 meters, 250 meters, or more, with a 120° horizontal FOV and a smaller 30° vertical FOV. Non-scanning-based LiDAR assembly 820 can cover a shorter detection range of, for example, 10 meters, 20 meters, 30 meters, or more, but with a 120° horizontal FOV and a larger 70° vertical FOV.

In some embodiments, scanning-based LiDAR assembly 810 includes a rotating polygon having multiple reflective facets. The multiple facets may have varying facet angles, each facet covering a smaller vertical angle range. Scanning-based LiDAR assembly 810 further includes a transceiver assembly with multiple channels. A scanning-based LiDAR assembly can have a one-dimensional sensor array, with a typical pixel count of, for example, 1×16, 1×32, 1×64, 1×128, etc. Non-scanning-based LiDAR assembly 820 can include fixed laser sources for illumination and fixed detection arrays for detecting return light scattered by near-distance objects.

In some embodiments, non-scanning-based LiDAR assembly 820 can be a flash LiDAR system. A flash LiDAR system can have a two-dimensional sensor array, with a typical resolution of 320×240 pixels. A flash LiDAR system has a laser source that can simultaneously transmit a diverging, two-dimensional planar laser light with an angular range sufficient to illuminate objects in the FOV in a single pulse. The receiving optics also captures return light in two dimensions. Compared to scanning-based LiDAR systems, a flash LiDAR system has no moving parts, has a higher signal-to-noise ratio, can detect objects in shorter distance, but can have a considerably larger vertical FOV.

In some embodiments, laser sources of scanning-based LiDAR assembly 810 and non-scanning-based LiDAR assembly 820 are configured to generate laser beams at different wavelengths. In one embodiment, scanning-based LiDAR assembly 810 generates laser beams at 905 nm. Non-scanning-based LiDAR assembly 820 generates laser light at 940 nm.

The vertical FOVs of scanning-based LiDAR assembly 810 and non-scanning-based LiDAR assembly 820 can be adjusted so that they overlap. FIG. 8B illustrates a vertical FOV of a LiDAR system capable of detecting objects in blind-spot areas from a side view. LiDAR system 800 includes a scanning-based LiDAR assembly 810 and a non-scanning-based LiDAR assembly 820 enclosed in a housing. Similar to FIG. 8A, window 805 facilitates the transmission of light to and from assemblies 810 and 820. The vertical FOV of scanning-based LiDAR assembly 810 is depicted by area 850. The angular range 851 of vertical FOV 850 in this example is from −10° to 20°. In this vertical range, scanning-based LiDAR assembly 810 can detect distanced object 880 located more than 100 meters away, for example, 150 meters, 200 meters, 250 meters, or more.

The vertical FOV of non-scanning-based LiDAR assembly 820 is depicted by area 860. The angular range 852 of vertical FOV 860 in this example is from 15° to 90°. In this vertical range, non-scanning-based LiDAR assembly 820 can detect near-distance object 890, up to a maximum detection point 865. In this embodiment, the vertical FOVs of scanning-based LiDAR assembly 810 and non-scanning-based LiDAR assembly 820 overlaps by 5°, depicted by area 870, resulting in the overall vertical FOV of LiDAR system 800 to be −10° to 90°.

In other embodiments, the vertical FOVs of the two assemblies 810 and 820 do not overlap, but are continuous to each other, so that they cover the entire vertical FOV of LiDAR system 800, which is −10° to 90°. For example, vertical FOV 850 may have an angular range of −10° to 20°, and vertical FOV 860 may have an angular range of 20° to 90°. In yet another embodiment, the non-overlapping vertical FOVs of the two assemblies 810 and 820 may not cover system 800's entire vertical FOV of −10° to 90°, i.e., a gap is left in the vertical FOV of system 800. For example, vertical FOV 850 may have an angular range of −10° to 20°, and vertical FOV 860 may have an angular range of 30° to 90°, leaving a 10° gap in-between FOV 850 and FOV 860.

In addition, the range of a vertical FOV of LiDAR system 800 is not limited to 0° to 90°. As explained above, a negative degree in vertical FOV means that the vertical FOV covers the area above the horizontal line, which is drawn horizontally from the LiDAR system. Moreover, a vertical FOV may cover vertical angles beyond 90°. A vertical angle beyond 90° is useful when the LiDAR system is installed on a structure protruding from the vehicle's main body, such as a side-view mirror or the supporting structure of a side-view mirror. Referring back to FIG. 7B, a LiDAR system capable of detecting objects in blind-spot areas (not shown in the figure) may be installed on the outer edge of the side-view mirror 704. A vertical FOV range over 90° refers to the area in-between the gravity line from the outer edge of mirror 704 (not shown in the figure) and the right side of the vehicle's body.

Referring back to FIG. 8B, an exemplary vertical FOV 860 of non-scanning-based LiDAR assembly 820 ranges from 15° to 90°, with line 861 depicting the 90° line, and line 862 depicting the 15° line. Lines 861 and 862 intersect with ground 866 at points 863 and 864, respectively. To detect near-distance objects within a large vertical FOV, assembly 820 needs to aim downwards. Thus, the maximum distance assembly 820 can detect is either the capacity of assembly 820, which can be 30 meters or more, or the distance from 820 to point 864, whichever is greater. The distance from 820 to 864 can be calculated by the vertical distance between 820 and 863 divide by a cosine of angle 852. For example, if angle 852 is 70°, then assuming the vehicle's side-view mirror, where assembly 820 is installed, is 1.5 meters above ground, the farthest distance non-scanning-based LiDAR assembly 820 can detect is 1.5 m÷cos(70°)=4.4 m.

FIG. 8C illustrates an embodiment of a LiDAR system enclosed in a housing for detecting objects in blind-spot areas. Scanning-based LiDAR assembly 810 and non-scanning-based LiDAR assembly 820 are enclosed in housing 801. The height of the housing 801 can be equal to or less than about 35-40 mm. Housing 801 can be installed in a vehicle's side-view mirror compartment, supporting structure of a side-view mirror, or the vehicle's side panel. In some examples, housing 801 is the vehicle's side-view mirror compartment or the vehicle's side panel. Window 805, which is situated on housing 801, facilitates the transmission of outgoing light from, and the transmission of return light to, both assemblies 810 and 820. In some embodiments, housing 801 may have two or more windows, with at least one window situated in front of scanning-based LiDAR assembly 810, and at least one other window situated in front of non-scanning-based LiDAR assembly 820. Window 805 is situated in the front of housing 801. In other embodiments, one or more windows could face different directions and can be located at the top, bottom, front, back or on the side of housing 801.

It should be understood that assemblies 810 and 820 can take any relative positions with respect to each other, and they can be positioned at any position within housing 801. In the example shown in FIG. 8C, assembly 820 is positioned to the left of assembly 810 (if viewing from the front of LiDAR system 800, i.e., facing window 805). In other embodiments, assemblies 810 and 820 can be in any relative positions with respect to each other. For example, they can be left-right or top-bottom with respect to each other. In other embodiments, they can be inside-outside with respect to each other, i.e., assembly 820 can be inside assembly 810, or vice versa. Assemblies 810 and 820 can also take any positions within housing 801. In some embodiments, either assembly 810 or assembly 820 can in the left, middle, right, top, bottom, front or back of housing 801.

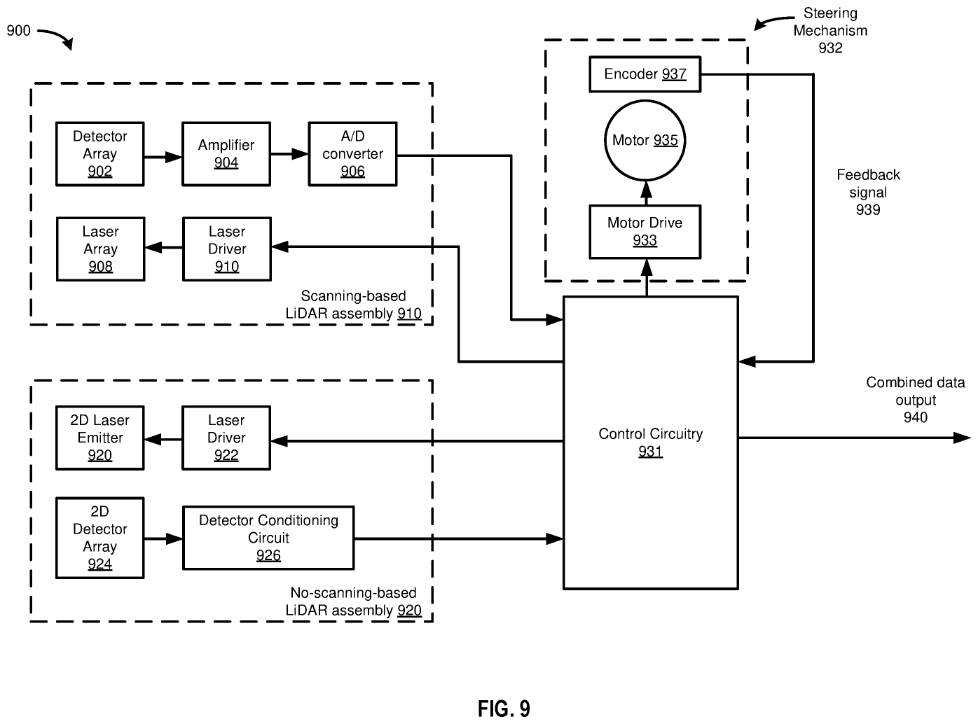

FIG. 9 is a block diagram of a LiDAR system capable of detecting objects in blind-spot areas according to one embodiment. LiDAR system 900 includes two assemblies, namely, scanning-based LiDAR assembly 910 and non-scanning-based LiDAR assembly 920. Scanning-based LiDAR assembly 910 includes laser array 908 and laser driver 910 on the transmitting side, and detector array 902, amplifier 904 and A/D converter 906 on the receiving side. Laser driver 910 is controlled by control circuitry 931, whose control functions are similar to control circuitry 350 in FIG. 3. Control circuitry 931 could be implemented with field-programmable gate array (“FPGA”) and/or System-On-Chip (“SOC”). Laser array 908 is driven by laser driver 910 and could have a laser emitter array of 1×8, 2×4, 1×16, 1×64, and so forth. Laser array 908 and laser driver 910 perform the functions of laser source 310 in FIG. 3.

On the receiving side of scanning-based LiDAR assembly 910, detector array 902 receives returned scattered light and could be in an array of 1×8, 2×4, 1×16, 1×64, and so forth. In some embodiments, the configuration of detector array 902 matches the configuration of laser array 908. For example, if laser array 908 has 4 arrays of 1×8 emitters, detector array 902 would also have 4 arrays of 1×8 detectors. In other embodiments, the configurations of detector arrays and laser arrays may be different. Output of detector array 902 are analog signals of return light pulses, which are being amplified by amplifier 904 and passed to analog to digital (A/D) converter 906. The output of A/D converter 906 is a digital signal of return light pulses, and is forwarded to control circuitry 931 for processing.

Still referring to FIG. 9, in some embodiments, non-scanning-based LiDAR assembly 920 includes two-dimensional (2-D) laser emitter 920 and laser driver 922 on the transmitting side, and two-dimensional (2-D) detector array 924 and detector conditioning circuit 926 on the receiving side. In one embodiment, assembly 920 can be a flash LiDAR system. Laser driver 922 is controlled by control circuitry 931 to drive the 2-D laser emitter 920 to generate 2-D planar rays. In one embodiment, 2-D laser emitter 920 can generate laser field with a typical resolution of 320×240 pixels. On the receiving side, returned scattered light is detected by 2-D detector array 924. In some embodiments, 2-D detector array 924 has the same resolution as 2-D laser emitter 920. In other embodiments, 2-D detector array 924 may have a different resolution from 2-D laser emitter 920. Light signals detected by 2-D detector array 924 are sent to detector conditioning circuit 926 to process timing and signal conditioning. The output of detector conditioning circuit 926 is a digital signal of return light pulses, and is forwarded to control circuitry 931 for processing.

LiDAR system 900 also includes a steering mechanism 932, whose functionality is similar to steering mechanism 340 in FIG. 3. In some embodiments, steering mechanism 932 includes motor drive 933, motor 935 and encoder 937. Motor drive 933 is controlled by control circuitry 931 and causes motor 935 to rotate according to a rotational speed set by control circuitry 931. Motor 935 is attached to a multi-facet polygon mirror (described in greater detail below). Thus, rotation of motor 935 will cause the polygon mirror to rotate in the same direction and rotational speed. Encoder 937 measures the actual rotational speed of motor 935 and provides the motor's actual rotational speed as feedback signal 939 back to control circuitry 931. Control circuitry 931 may, based on feedback signal 939, adjust its control of motor drive 933 so that motor 935's rotational speed can be fine-tuned.

Detector array 902 of scanning-based LiDAR assembly 910 is configured to generate signals representing a mapping of the FOV for the scanning-based assembly. 2D detector array 924 of non-scanning-based LiDAR assembly 920 is configured to generate signals representing a mapping of the FOV for the non-scanning-based assembly. As previously discussed, LiDAR system 900 may or may not have overlapping vertical FOVs from the two assemblies 910 and 920. In case of no vertical overlap, the vertical FOV of scanning-based LiDAR assembly 910 can be from −10° to 20°, and the vertical FOV of non-scanning-based LiDAR assembly 920 can be from 20° to 90°. To produce a complete point cloud covering data points from both assemblies, data points from both assemblies are combined in control circuitry 931 to produce a unified point cloud. When there is overlap in the FOVs, control circuitry 931 may choose the overlapped data points generated by one assembly, and discard data points generated by the other assembly for the same FOV. In some embodiments, control circuitry 931 may combine overlapped data points generated by the two assembly to produce a better-quality point cloud.

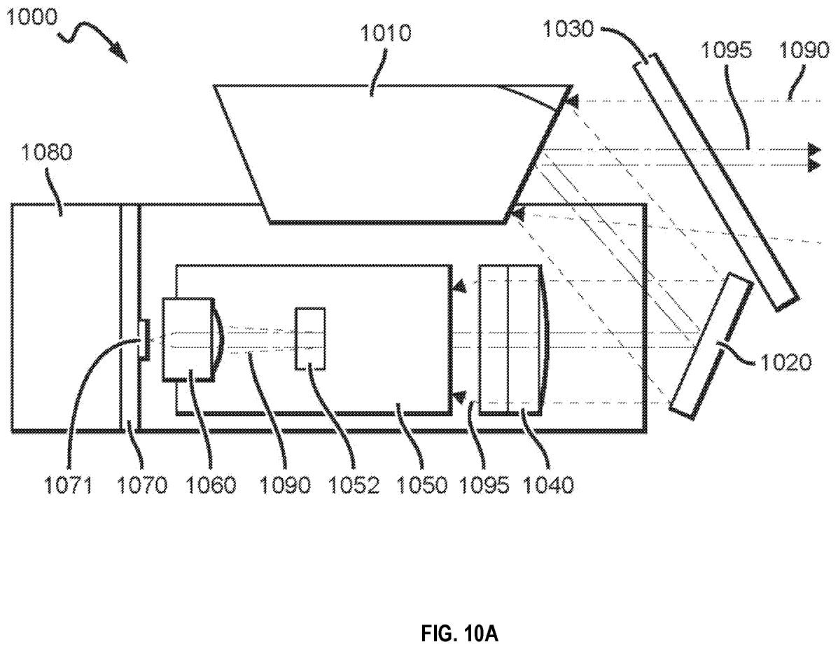

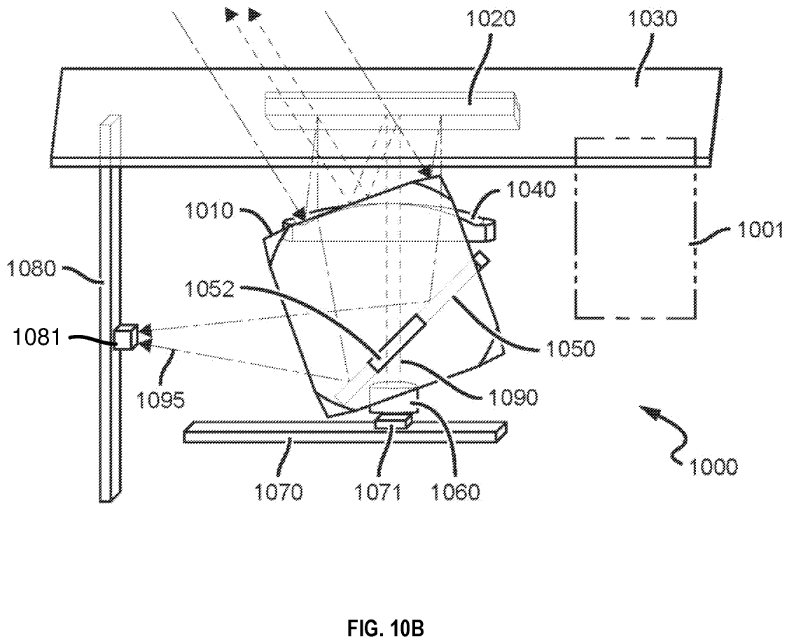

FIG. 10A illustrates a cross-section view of a scanning-based LiDAR assembly according to one embodiment. FIG. 10B illustrates a scanning-based LiDAR assembly from the top view. Scanning-based LiDAR assembly 1000 includes polygon mirror 1010, folding mirror 1020, receiving lens 1040, combining mirror 1050, collimation lens 1060, laser circuit board 1070, and detector circuit board 1080. In addition, FIG. 10B also shows space 1001, which is reserved for non-scanning-based LiDAR assembly 820.

Referring back to FIG. 10A, in some embodiments, laser source 1071 on laser circuit board 1070 generate one or more channels of outgoing laser light, in the form of multiple laser beams. The laser beams are directed to collimation lens 1060 to collimate the outgoing light beams. One of the outgoing light beams is depicted as light beam 1090. Combining mirror 1050 has one or more openings. Opening 1052 allows outgoing light beam 1090 to pass through the mirror. As shown more clearly in FIG. 10B, the reflective surface of combining mirror 1050 (on the opposite side of laser source 1071) redirects the return light to light detector 1081 on detector circuit board 1080. In one embodiment, opening 1052 is located in the center of combining mirror 1050. In other embodiments, opening 1052 can be located in other parts of combining mirror that is not the center. In yet other embodiments, the opening of a combining mirror is configured to pass the collected return light to a light detector, and the remaining portion of the combining mirror is configured to redirect the plurality of light beams from the laser source.

Back to FIG. 10A, the collimated light beams are then directed through opening 1052 of combining mirror 1050, and then to folding mirror 1020. Folding mirror 1020 is a fixed mirror designed to redirect outgoing light beams to polygon mirror 1010, which is situated above receiving lens 1040 and combining mirror 1050. Polygon mirror 1010 may have a plurality of facets. For example, polygon mirror 1010 may have 3 facets, 4 facets, 5 facets, 6 facets, and so forth. Outgoing light beams are reflected by a facet of the polygon mirror 1010 and are directed through window 1030 to illuminate the field-of-view.

If there are objects in the field-of-view, return light is scattered by the objects and are directed back through window 1030 to a facet of polygon mirror 1010. Then, return light travels back to folding mirror 1020, which directs the return light to receiving lens 1040. Referring to FIG. 10B, receiving lens 1040 focuses return light to a small spot size. Then, return light is reflected by combining mirror 1050 by about 90° to detector circuit board 1080 on the side. Return light are detected by detector array 1081 on detector circuit board 1080.

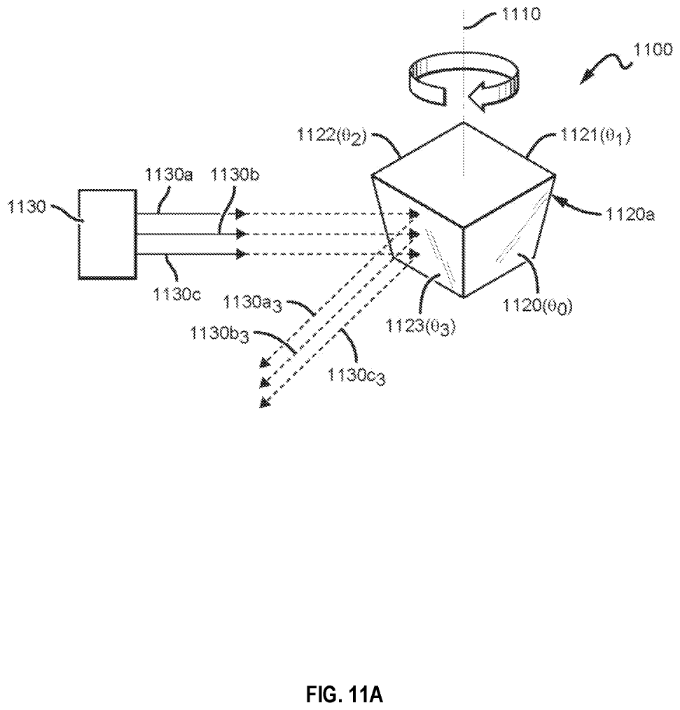

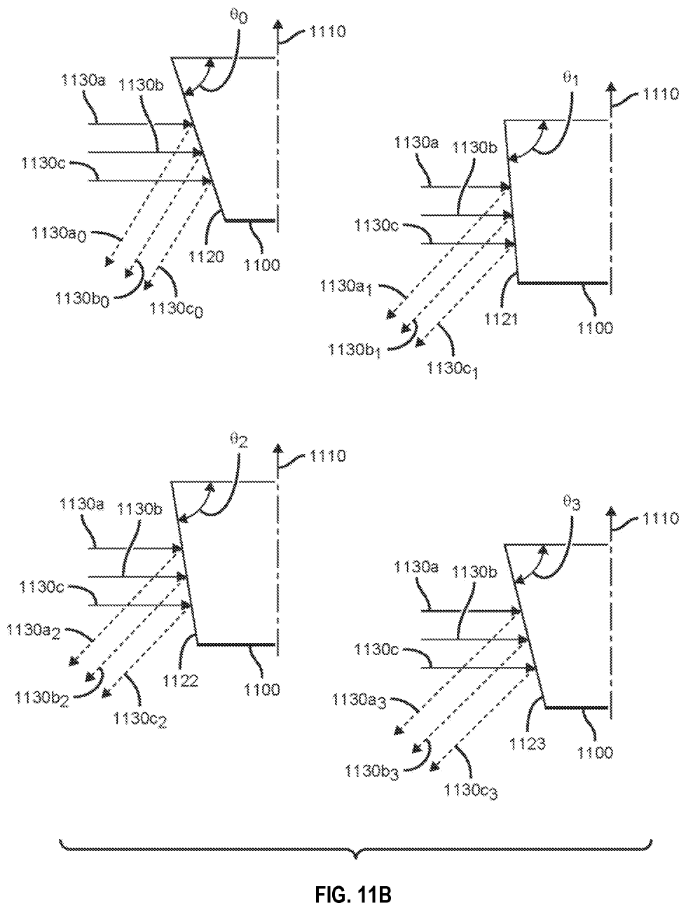

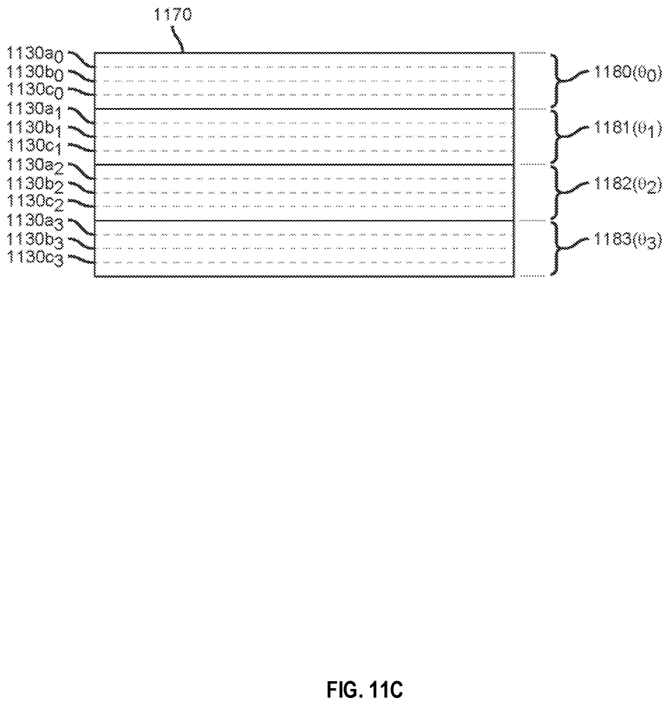

In some embodiments, multi-facet polygon mirror 1010 is a variable angle multi-facet polygon (VAMFP) according to one embodiment. FIG. 11A illustrates a perspective view of a variable angle multi-facet polygon according to one embodiment. FIG. 11B illustrates side views of each facet of a variable angle multi-facet polygon according to one embodiment. FIG. 11C illustrates a LiDAR system FOV with a combined bands from the plurality of facets of VAMFP according to one embodiment. VAMFP is described in more detail in U.S. non-provisional patent application Ser. No. 16/837,429, filed on Apr. 1, 2020, entitled “Variable Angle Polygon For Use With A Lidar System”, the content of which is incorporated by reference in it is entirety for all purposes.

Back to FIG. 11A, variable angle multi-facet polygon 1100 rotates about axis 1110. VAMFP 1100 can include 4 reflective surfaces (facets). As discussed herein, each facet may be referred to by its index, namely, facets 0, 1, 2 and 3, or may be referred to by its reference numbers, namely, facet 1120, 1121, 1122 and 1123, respectively. Laser source 1130, which is similar to laser source 1071 in FIG. 10A, generates multiple laser beams 1130a-1130c. Through collimation lens or lens group (not shown in the figure), beams 1130a-1130c are aimed towards one of the 4 facets of VAMFP 1100. As VAMFP 1100 rotates about axis 1110, laser source 1130 interfaces with each of facets 1120, 1121, 1122 and 1123 in repeated succession. The beams redirected by each facet are depicted as beams 1130a′x′, with x being the index number of the facet reflecting the beams. For example, as illustrated in FIG. 11A, individual beams 1130a-1130c redirected by facet 3 (or facet 1123) are depicted as 1130a3, 1130b3 and 1130c3. As illustrated in FIG. 11B, beams redirected by facet 0 (or facet 1120) are depicted as 1130a0, 1130b0 and 1130c0.

FIG. 11B illustrates side views of facet 1120 (the top-left sub-figure), facet 1121 (the top-right sub-figure), facet 1122 (the bottom-left sub-figure) and facet 1123 (the bottom right sub-figure). Each of facets 1120, 1121, 1122 and 1123 has its own unique facet angle, shown as θ₀-θ₃, respectively. Facet angle of a facet represents the angle between the facet surface and the top planar surface of polygon 1100. Facet 1120 corresponds with facet angle θ₀, facet 1121 corresponds with facet angle θ₁, facet 1122 corresponds with facet angle θ₂, and facet 1123 corresponds with facet angle θ₃. In one embodiment, facet angles of polygon mirror 1100 are all 90 degrees. In other embodiments, such as the one shown in FIGS. 11A and 11B, facet angles of each facet of polygon mirror 1100 are less than 90 degrees, thereby forming wedged facets. A cross-section of polygon mirror 1100 may have a trapezoidal shape. FIG. 11B shows individual beams 1130a-1130c are being redirected by different facets 1120-1123.

Facet angle of each facet corresponds to a vertical range of scanning. The vertical range of scanning of at least one facet is different from the vertical ranges of other facets. FIG. 11C shows an illustrative LiDAR system FOV 1170 with four non-overlapping bands 1180-1183 in the FOV, each corresponding to the individual FOV produced by one of facets 1120-1123 and their respective facet angles θ₀-θ₃. FOV 1170 also shows redirected light beams 1130a0-1130c0, 1130a1-1130c1, 1130a2-1130c2 and 1130a3-1130c3 in respective bands 1180-1183. Each of bands 1180-1183 spans the entire horizontal axis of FOV 1170 and occupies a subset of the vertical axis of FOV 1170. Facet angles θ₀-θ₃ may be selected such that bands 1180-1183 cover the entire FOV of a LiDAR system and are contiguous in their adjacency relationships. In other embodiments, the bands can be non-contiguous and leave gaps in-between bands. In other embodiments, two or more bands may overlap with each other.

Each facet angle may be different from one another. The difference of facet angles of facets can be constant or variable. In some embodiments, the facet angles are 2.5 to 5 degrees apart, so that the total vertical range of scanning is about 20 to 40 degrees. For example, in one embodiment, facet angles are 4 degrees apart: θ₀ is 60°, θ₁ is 64°, θ₂ is 78°, and θ₃ is 72°. In other embodiments, facet angels are 9 degrees apart, resulting in a total vertical range of scanning to be about 72 degrees.

It should be understood that the use of four facets in VAMFP 1100 and a three-beam light beams in FIGS. 11A-11C are merely illustrative. A VAMFP may have any number of facets and any number of light beams may be used.

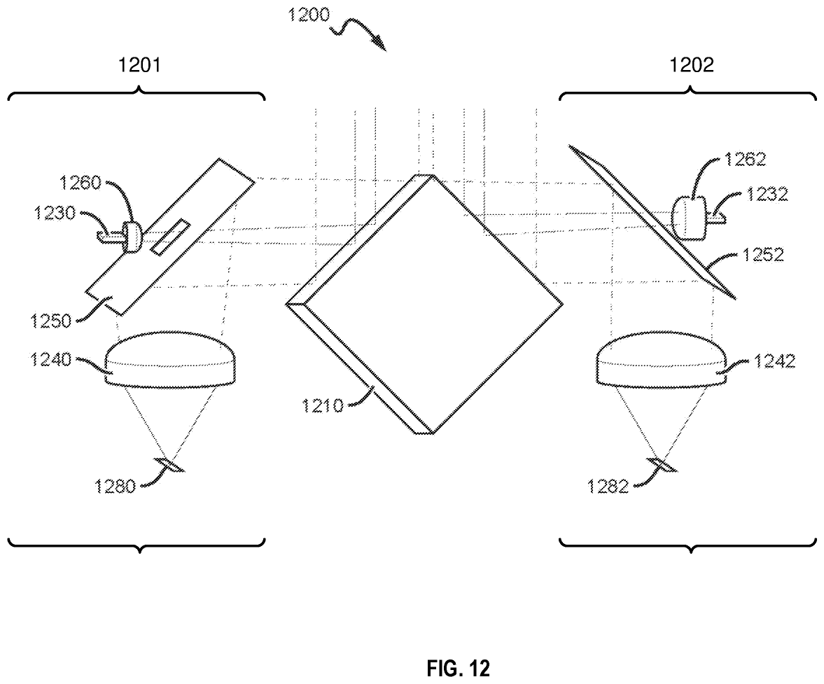

FIG. 12 illustrates a LiDAR system 1200 having a scanning LiDAR assembly but no non-scanning-based LiDAR assembly. LiDAR system 1200 has one rotatable polygon mirror 1210 with two separate arms. One arm is optimized for longer distance detection, and the other arm is optimized for nearby object detection with larger vertical angles. The data outputs from the two arms can be merged in a control circuitry (not shown in the figure), such as control circuitry 350 illustrated in FIG. 3, to generate a unified point-cloud data output. This embodiment also allows the LiDAR system to be built with a height of 35-40 mm or less, thus allowing the entire LiDAR system to be fitted easily in the vehicle side panel or side-view mirror compartment.

As shown in FIG. 12, LiDAR system 1200 is only scanning-based and has a shared polygon mirror 1210 with two arms on both sides of polygon mirror 1210. First arm 1201 is on the left side of FIG. 12, which includes light source 1230, collimation lens 1260, combining mirror 1250, receiving lens 1240 and light detector 1280. Second arm 1202 is on the right side of FIG. 12, which includes light source 1232, collimation lens 1262, combining mirror 1252, receiving lens 1242, and light detector 1282. The working mechanism of each arm is similar to that of the scanning-based LiDAR assembly depicted in FIG. 10A, except that no folding mirror is involved to redirect outgoing light beams by laser sources. Taking the first arm for example, light source 1230 generates one or more channels of outgoing laser light in the form of multiple laser beams. The laser beams are directed to collimation lens 1260 to collimate the outgoing light beams. The collimated light beams are then directed to a facet of shared polygon mirror 1210, which reflects the light beams to illuminate the field-of-view. If there are objects in the field-of-view, return light is scattered by the objects and are directed back to the same facet of shared polygon mirror 1210. Then, return light is reflected by combining mirror 1250 to receiving lens 1240, which focuses return light to a small spot size. Then. return light is detected by light detector 1280. The working mechanism of the second arm is the same as illustrated above for the first arm, except that the collimated outgoing light beams are directed (and the scattered light returning back) to a different facet of shared polygon mirror 1210.

Shared polygon mirror 1210 is a variable angle multi-facet polygon (VAMFP) and may have any number of facets. In some embodiments, VAMFP has 4 facets, each facet being referred to by its index, namely, facets 0, 1, 2 and 3. Among all the facets, certain facets are used exclusively by the first arm, and certain facets are used exclusively by the second arm. For example, the first arm may use facets 0 and 2, and the second arm may use facets 1 and 3. In some embodiments, the two arms may also share the use of one or more facets. Facets used by the first arm are hereinafter referred to as “first arm facets”, and facets used by the second arm are hereinafter referred to as “second arm facets”. For the two arms to share the use of the different facets of VAMFP 1210, control circuitry (not shown in the figure) is configured such that light source 1230 will transmit light beams only when it is facing a facet of first arm facets, and light source 1232 will transmit light beams only when it is facing a facet of second arm facets.

Some facets used by one arm may have the same facet angles with some facets used by the other arm, but at least one facet of one arm has a different facet angle from facet angles of all the facets of the other arm. In some embodiments, facet angles of first arm facets are greater than the respective facet angles of second arm facets. In some embodiments, facet angles of first arm facets are about 12 degrees, and the facet angles of second arm facets are about 3 degrees.

Control circuitry of LiDAR system 1200 (not shown in the figure) controls the first and second arms such that the second arm has a detection range greater than that of the first arm. The control circuitry controls the output power of the light source 1230 and light source 1232. In some embodiments, light sources 1230 and 1232 are configured to provide laser beams having two different wavelengths. In other embodiments, LiDAR system 1200 may have a laser source and optical components (not shown in the figure). The control circuitry is configured such that different portions of output power from the laser source are delivered to the first arm and the second arm separately.

In some embodiments, combining mirror 1250 has one or more openings that allow the passing of light beams generated by laser source 1230 to shared polygon mirror 1210. The remainder portion of the combining mirror (other than the openings) redirects the return light scattered by objects in the FOV to light detector 1280 through receiving lens 1240. Combining mirror 1252 also has one or more openings (not shown in the figure) and functions the same way as described above for combining mirror 1250. In other embodiments, the openings on combining mirror 1250 may operate in the opposite way, i.e., allowing the passing of return light scattered by objects in the FOV, and redirecting light beams generated by laser source 1230 to shared polygon mirror 1210.

Light detectors 1280 and 1282 have sensor arrays configured to generate signals representing different portions of FOVs of the two arms, which may or may not overlap. The control circuitry combines data points from both light detectors 1280 and 1282 to generate a unified point cloud representing both FOVs of the two arms. When there is overlap in the FOVs of the two arms, the control circuitry may choose the overlapped data points generated by one arm, and discard data points generated by the other arm for the same FOV. In some embodiments, control circuitry may combine overlapped data points generated by the two arms to produce a better-quality point cloud.

FIG. 13 is a flowchart illustrating a method for detecting objects in blind-spot areas. In some embodiments, method 1300 may be performed by a LiDAR system such as LiDAR system 800 in FIGS. 8A-8C, system 900 shown in FIG. 9, or system 1200 shown in FIG. 12. Method 1300 includes step 1310, in which a scanning-based LiDAR assembly (e.g., assembly 810) disposed in a housing of a LiDAR system scans a plurality of light beams to illuminate a first FOV. Method 1300 further includes step 1320, in which a non-scanning-based LiDAR assembly (e.g., assembly 820) disposed in the housing transmits laser light to illuminate a second FOV without scanning. The scanning-based LiDAR assembly's detection distance range extends beyond the detection distance range of the non-scanning-based LiDAR assembly.

In some embodiments, method 1300 further includes step 1330, in which a fixed mirror (e.g., 1020) of the scanning-based LiDAR assembly directs the plurality of light beams to a multi-facet polygon (e.g., polygon 1010). In some embodiments, method 1300 further includes steps 1340-1360. At step 1340, a collimation lens (e.g., lens 1060) optically coupled to a first laser source collimates the plurality of light beams provided by the first laser source. At step 1350, a receiving lens (e.g., lens 1040) collects return light generated based on the illumination of the first FOV. At step 1360, a combining mirror (e.g., mirror 1050) disposed between the collimation lens and the receiving lens directs both the plurality of light beams provided by the first laser source and the collected return light. In some embodiments, method 1300 further includes steps 1370-1380. At step 1370, a first sensor array of the scanning-based LiDAR assembly generates signals representing a mapping of the first FOV. At step 1380, a second sensor array of the non-scanning-based LiDAR assembly generates signals representing a mapping of the second FOV. A two-dimensional sensing by a LiDAR assembly can generate a 3D point cloud for mapping the external environment of the LiDAR system, similar to those described above.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A light detection and ranging (LiDAR) system for detecting objects in blind-spot areas, comprising:
a housing;
a scanning-based LiDAR assembly disposed in the housing, the scanning-based LiDAR assembly being configured to scan a plurality of light beams to illuminate a first field-of-view (FOV); and
a non-scanning-based LiDAR assembly disposed in the housing, the non-scanning-based LiDAR assembly being configured to transmit laser light to illuminate a second FOV without scanning,
wherein a detection distance range of the scanning-based LiDAR assembly extends beyond a detection distance range of the non-scanning-based LiDAR assembly.

2. The LiDAR system of claim 1, wherein a vertical range scanned by the scanning-based LiDAR assembly overlaps with a vertical range illuminated by the non-scanning LiDAR assembly.

3. The LiDAR system of claim 1, wherein a vertical range scanned by the scanning-based LiDAR assembly does not overlap with a vertical range illuminated by the non-scanning LiDAR assembly.

4. The LiDAR system of claim 1, wherein the detection distance range of the scanning based LiDAR assembly is up to 200 meters.

5. The LiDAR system of claim 1, wherein the detection distance range of the non-scanning-based LiDAR assembly is up to 30 meters.

6. The LiDAR system of claim 1, wherein the scanning-based LiDAR assembly comprises a multi-facet polygon that is rotatable to scan the plurality of light beams to illuminate the first FOV, and wherein the non-scanning-based LiDAR assembly comprises a flash LiDAR device configured to simultaneously illuminate the second FOV in a single light pulse.

7. The LiDAR system of claim 6, wherein the scanning-based LiDAR assembly further comprises a fixed mirror configured to direct the plurality of light beams to the multi-facet polygon.

8. The LiDAR system of claim 6, wherein the multi-facet polygon is a variable angle multi-facet polygon (VAMFP), the VAMFP comprising a plurality of facets each having a facet angle, the facet angle of each facet corresponding to a vertical range of scanning, wherein the vertical range of at least one facet is different from the vertical ranges of other facets.

9. The LiDAR system of claim 8, wherein the VAMFP comprises four facets having facet angles of about 2.5 to 5 degrees apart, wherein the facet angles of the plurality of facets are configured such that a total vertical range of scanning of all the four facets is about 20 to 40 degrees.

10. The LiDAR system of claim 8, wherein the plurality of vertical ranges of all the facets are non-overlapping vertical ranges.

11. The LiDAR system of claim 8, wherein at least two vertical ranges of the plurality of facets are overlapping vertical ranges.

12. The LiDAR system of claim 1, wherein the scanning-based LiDAR assembly comprises a first laser source configured to provide the plurality of light beams at a first wavelength; wherein the non-scanning-based LiDAR assembly comprises a second laser source configured to provide the laser light at a second wavelength, the second wavelength being different from the first wavelength.

13. The LiDAR system of claim 12, wherein the scanning-based LiDAR assembly further comprises:
a collimation lens optically coupled to a first laser source, the collimation lens being configured to collimate the plurality of light beams provided by the first laser source;
a receiving lens configured to collect return light generated based on the illumination of the first FOV; and
a combining mirror disposed between the collimation lens and the receiving lens.

14. The LiDAR system of claim 13, wherein the combining mirror comprises:
a first portion configured to allow passing of the plurality of light beams from the first laser source; and
a second portion configured to redirect the collected return light to a light detector.

15. The LiDAR system of claim 14, wherein the first portion is a center portion of the combining mirror and the second portion is a portion of the combining mirror that is other than the center portion.

16. The LiDAR system of claim 13, wherein the combining mirror comprises:
a first portion configured to allow passing of the collected return light to a light detector; and
a second portion configured to redirect the plurality of light beams from the first laser source.

17. The LiDAR system of claim 1, wherein the housing comprises:
one or more windows disposed in the housing, wherein the one or more windows are configured to:
facilitate passing the plurality of light beams scanned by the scanning-based LiDAR assembly to illuminate the first FOV, and
facilitate passing the laser light transmitted by the non-scanning-based LiDAR assembly to illuminate the second FOV.

18. The LiDAR system of claim 1, wherein the non-scanning-based LiDAR assembly is configured to transmit a diverging laser light with an angular range sufficient to illuminate the entire second FOV in a single pulse.

19. The LiDAR system of claim 1, wherein the scanning-based LiDAR assembly comprises a first sensor array configured to generate signals representing a mapping of the first FOV; and
wherein the non-scanning-based LiDAR assembly comprises a second sensor array configured to generate signals representing a mapping of the second FOV.

20. The LiDAR system of claim 19, further comprising a processing circuitry configured to generate a unified point cloud representing both the first FOV and the second FOV based on the signals representing the mapping of the first FOV and the signals representing the mapping of the second FOV, wherein the first FOV and the second FOV at least partially overlap.

21. The LiDAR system of claim 1, wherein a height of the LiDAR system is equal to or less than about 35-40 mm or is configured such that the LiDAR system is installable in a vehicle's side-view mirror or a support structure thereof.

22. A method performed by a light detection and ranging (LiDAR) system for detecting objects in blind-spot areas, the method comprising:
scanning, by a scanning-based LiDAR assembly disposed in a housing of the LiDAR system, a plurality of light beams to illuminate a first FOV; and
transmitting, by a non-scanning-based LiDAR assembly disposed in the housing, laser light to illuminate a second FOV without scanning,
wherein a detection distance range of the scanning-based LiDAR assembly extends beyond a detection distance range of the non-scanning-based LiDAR assembly.

23. The method of claim 22, wherein scanning the plurality of light beams to illuminate the first FOV comprises controlling to rotate a multi-facet polygon of the scanning-based LiDAR assembly to scan the plurality of light beams to illuminate the first FOV; and
wherein transmitting the laser light to illuminate the second FOV without scanning comprises simultaneously illuminating the second FOV in a single light pulse by using a flash LiDAR device.

24. The method of claim 22, wherein scanning the plurality of light beams to illuminate the first FOV further comprises directing, by a fixed mirror of the scanning-based LiDAR assembly, the plurality of light beams to the multi-facet polygon.

25. The method of claim 22, further comprising:
providing, by a first laser source of the scanning-based LiDAR assembly, the plurality of light beams at a first wavelength; and
providing, by a second laser source of the non-scanning-based LiDAR assembly, the laser light at a second wavelength, the second wavelength being different from the first wavelength.

26. The method of claim 25, further comprising:
collimating, by a collimation lens optically coupled to the first laser source, the plurality of light beams provided by the first laser source;
collecting, by a receiving lens, return light generated based on the illumination of the first FOV; and
directing, by a combining mirror disposed between the collimation lens and the receiving lens, both the plurality of light beams provided by the first laser source and the collected return light.

27. The method of claim 22, further comprising:
generating, by a first sensor array of the scanning-based LiDAR assembly, signals representing a mapping of the first FOV; and
generating, by a second sensor array of the non-scanning-based LiDAR assembly, signals representing a mapping of the second FOV.

28. The method of claim 26, further comprising generating, by a processing circuitry, a unified point cloud representing both the first FOV and the second FOV based on the signals representing the mapping of the first FOV and the signals representing the mapping of the second FOV, wherein the first FOV and the second FOV at least partially overlap.
